(19) United States
(12) Patent Application Publication
(10) Pub. No.: US 2013/0314372 A1
(43) Pub. Date: Nov. 28, 2013

(54) DISPLAY STRUCTURE WITH TOUCH CONTROL FUNCTION

(71) Applicant: Wintek Corporation, Taichung City (TW)

(72) Inventors: Ting-Yu Chang, Kaohsiung City (TW); Ching-Fu Hsu, Taichung City (TW); Chin-Chang Liu, Taichung City (TW); Yu-Hung Chang, Miaoli County (TW); Wen-Chun Wang, Taichung City (TW)

(21) Appl. No.: 13/899,600

(22) Filed: May 22, 2013

(30) Foreign Application Priority Data
May 28, 2012 (TW) 101118938

(51) Int. Cl. G06F 3/044

(52) U.S. Cl. CPC G06F 3/044
USPC 345/174

(57) ABSTRACT

An organic light emitting diode display structure with touch control function includes a plurality of organic light emitting diodes arranged in a matrix form, a plurality of first switches, a plurality of first sensing stripes arranged along a first direction, a plurality of second sensing stripes arranged along a second direction, and a touch control circuit. Each of the first switches is coupled between a first end of one of the plurality of organic light emitting diodes and a voltage source. Each of the second sensing stripes is coupled to a plurality of second ends of at least one of rows of the plurality of organic light emitting diodes. The touch control circuit is for generating touch signals according to capacitance values between the plurality of first sensing stripes and the plurality of second sensing stripes.

### BACKGROUND OF THE INVENTION

1. Field of the Invention

The present invention relates to a display structure, and more particularly, to a light emitting device display structure with touch control function.

2. Description of the Prior Art

As related technology keeps improving, functions of portable electronic devices become more powerful. Current portable electronic devices can be utilized for processing data, making calls, surfing Internet, executing application programs or video games. In order to operate the portable electronic device more easily, various kinds of input devices and input methods are gradually developed, wherein the touch control technique is the most popular input method currently. The touch control technique generates touch signals by sensing movement of a finger of a user on a touch screen, and the portable electronic device then operates by determining commands inputted by the user according to touch signals transmitted from the touch screen. Therefore, physical buttons can be reduced or removed from the portable electronic device when inputting. However, the current touch screen is generally provided with a touch panel attached on a display panel, such that the touch screen of the prior art is thicker. Accordingly, thickness of the portable electronic device having the touch screen of the prior art can not be further reduced.

### SUMMARY OF THE INVENTION

The present invention provides an organic light emitting diode display structure with touch control function, which comprises a plurality of organic light emitting diodes arranged in a matrix form, a plurality of first switches, a plurality of first sensing stripes arranged along a first direction, a plurality of second sensing stripes arranged along a second direction, and a touch control circuit. Each of the first switches is coupled between a first end of one of the plurality of organic light emitting diodes and a voltage source. Each of the second sensing stripes is coupled to a plurality of second ends of at least one of rows of the plurality of organic light emitting diodes. The touch control circuit is coupled to the plurality of first sensing stripes and the plurality of second sensing stripes for generating touch signals according to capacitance values between the plurality of first sensing stripes and the plurality of second sensing stripes.

The present invention further provides an organic light emitting diode display structure with touch control function, which comprises a circuit substrate, a plurality of organic light emitting diodes, a plurality of first sensing stripes arranged along a first direction, a plurality of second sensing stripes arranged along a second direction, and a touch control circuit. The plurality of organic light emitting diodes are formed on the circuit substrate in a matrix form. A plurality of first ends of the plurality of organic light emitting diodes are coupled to the circuit substrate. Each of the second sensing stripes is coupled to a plurality of second ends of at least one of rows of the plurality of organic light emitting diodes, and each of the second sensing stripes is separated for each other by at least one row of the plurality of organic light emitting diodes. The touch control circuit is coupled to the plurality of first sensing stripes and the plurality of second sensing stripes for generating touch signals according to capacitance values between the plurality of first sensing stripes and the plurality of second sensing stripes.

In contrast to the prior art, the present invention arranges the first sensing stripes on a protection substrate and couples the second sensing stripes to the cathodes of the organic light emitting diodes for integrating a display mechanism and a touch control mechanism into the organic light emitting diode display structure of the present invention. Therefore, thickness of a touch screen utilizing the organic light emitting diode display structure of the present invention can be further reduced, and production yields of the touch screen utilizing the organic light emitting diode display structure of the present invention can be further improved by skipping a step of attaching a touch panel onto a display panel.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing an organic light emitting diode display structure with touch control function of the present invention.

FIG. 2 is a diagram showing second sensing stripes of FIG. 1 being coupled to cathodes of rows of a plurality of organic light emitting diodes.

FIG. 3 is a diagram showing a touch control mechanism of the organic light emitting diode display structure of the present invention.

FIG. 4 is a circuit diagram showing a display mechanism of the organic light emitting diode display structure of the present invention.

FIG. 5 is a diagram showing voltage signals of the control ends of the first switch and the second switch of FIG. 4.

FIG. 6 is a diagram showing another embodiment of the second sensing stripes of FIG. 1 being coupled to the cathodes of the rows of the plurality of organic light emitting diodes.

FIG. 7 is a diagram showing another embodiment of the organic light emitting diode display structure with touch control function of the present invention.

### DETAILED DESCRIPTION

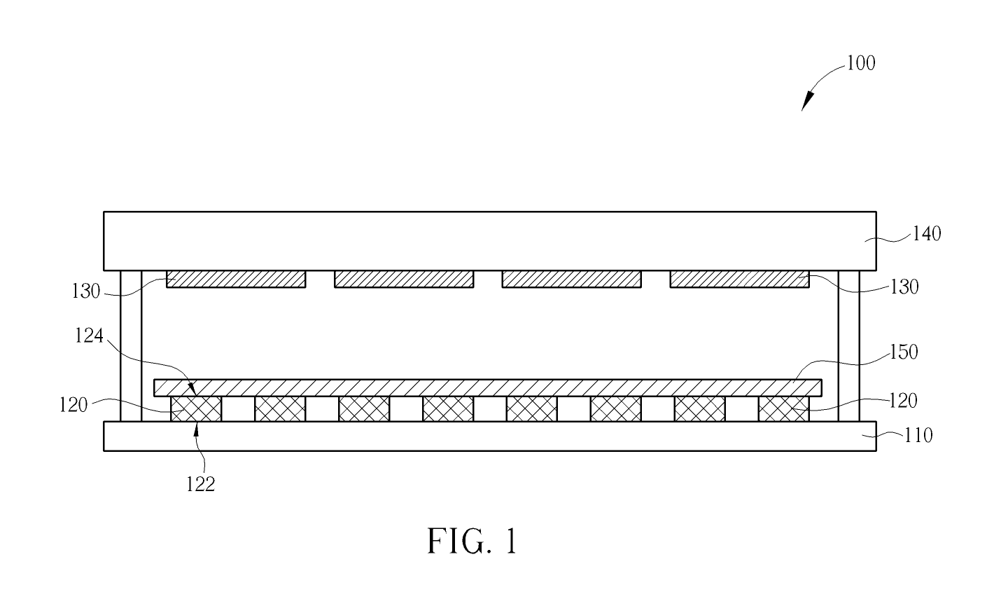

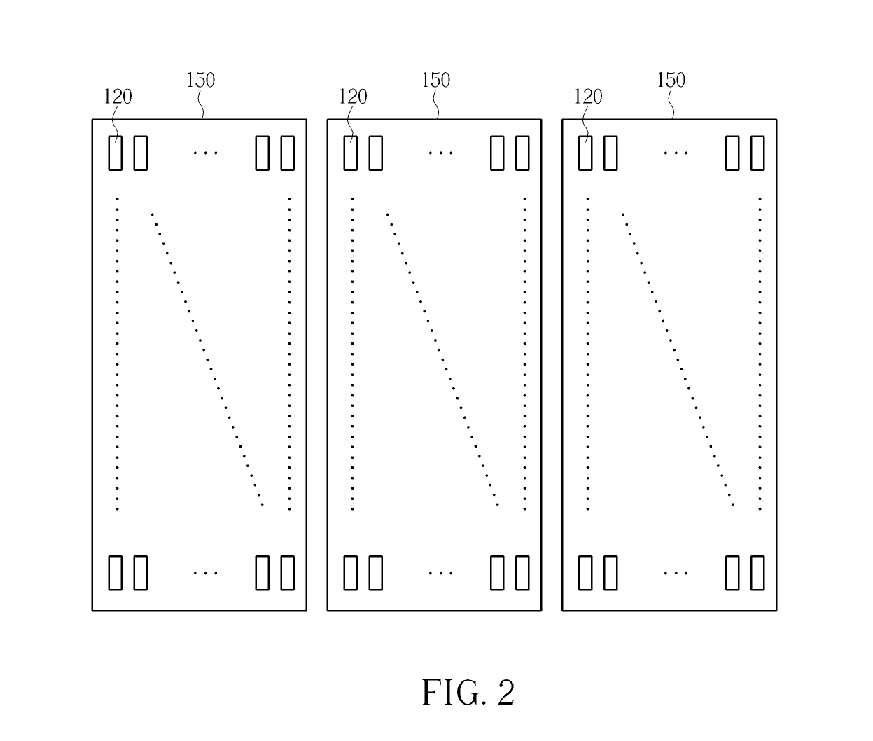

Please refer to FIG. 1 and FIG. 2 together. FIG. 1 is a diagram showing an organic light emitting diode display structure 100 with touch control function of the present invention. FIG. 2 is a diagram showing second sensing stripes 150 of FIG. 1 being coupled to cathodes 124 of rows of a plurality of organic light emitting diodes 120. As shown in figures, the organic light emitting diode display structure 100 of the present invention comprises the plurality of organic light emitting diodes 120 formed on a circuit substrate 110 in a matrix form. An anode 122 of each organic light emitting diode 120 is coupled to the circuit substrate 110. A plurality of first sensing stripes 130 are arranged on a protection substrate 140 along a first direction. The plurality of second sensing stripes 150 are arranged along a second direction (perpendicular to the first direction), and each of the second sensing stripes 150 is coupled to the cathodes 124 of the rows of the plurality of organic light emitting diodes 120.

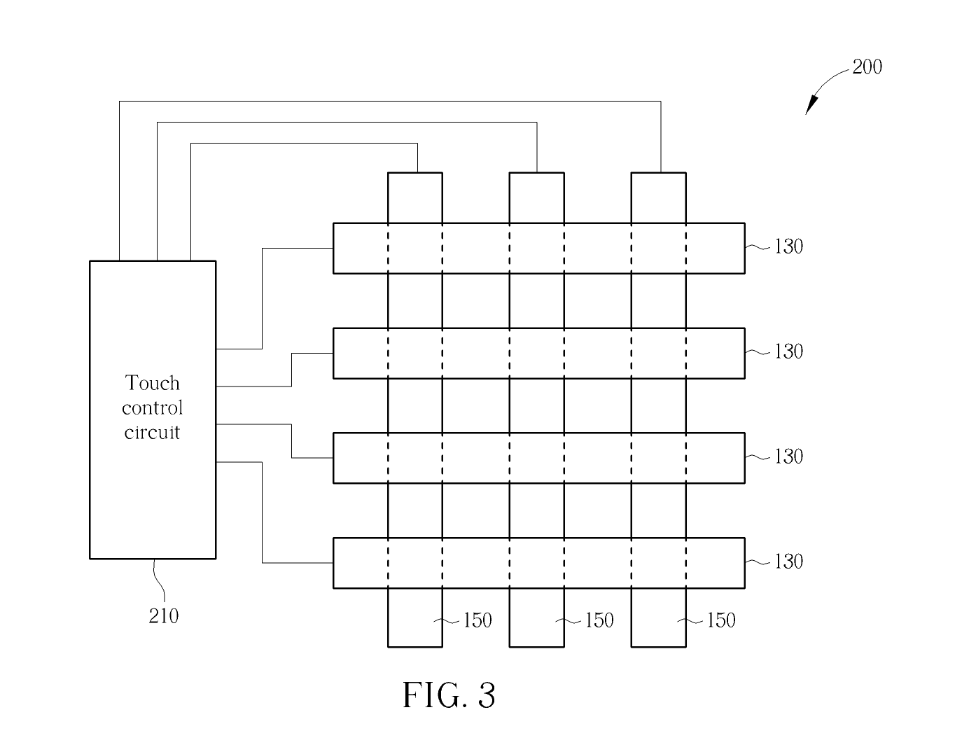

Please refer to FIG. 3, and refer to FIG. 1 and FIG. 2 as well. FIG. 3 is a diagram showing a touch control mechanism 200 of the organic light emitting diode display structure of the present invention. As shown in FIG. 3, the organic light emitting diode display structure of the present invention further comprises a touch control circuit 210 coupled to the plurality of first sensing stripes 130 and the plurality of second sensing stripes 150. The plurality of first sensing stripes 130 can be utilized as scanning electrodes, and the plurality of second sensing stripes 150 can be utilized as sensing electrodes. Or the plurality of first sensing stripes 130 can be utilized as sensing electrodes, and the plurality of second sensing stripes 150 can be utilized as scanning electrodes. According to the above arrangement, the touch control circuit 210 can generate touch signals according to capacitance values between the plurality of first sensing stripes and the plurality of second sensing stripes.

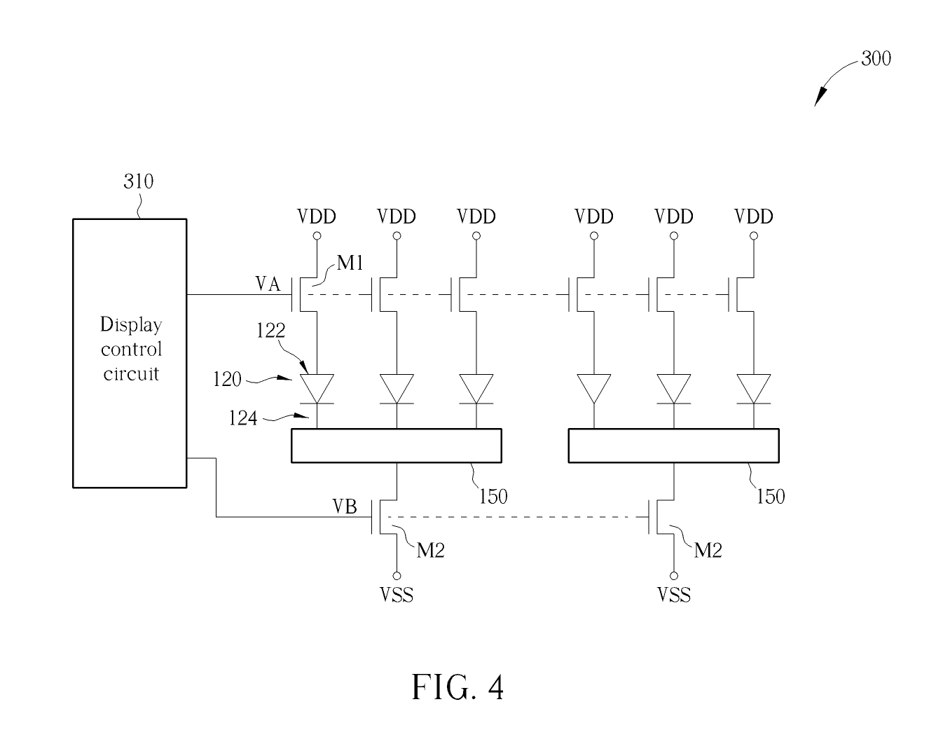

Please refer to FIG. 4, and refer to FIG. 3 as well. FIG. 4 is a circuit diagram showing a display mechanism 300 of the organic light emitting diode display structure of the present invention. As shown in FIG. 4, the organic light emitting diode display structure of the present invention further comprises a plurality of first switches M1, a plurality of second switches M2, and a display control circuit 310. Each of the first switches M1 is coupled between an anode of one of the plurality of organic light emitting diodes 120 and a voltage source VDD. Each of the second switches M2 is coupled between one of the plurality of second sensing stripes 150 and ground VSS. The display control circuit 310 is coupled to control ends of the first switch M1 and the second switch M2 for controlling on and off states of the first switch M1 and the second switch M2. When the first switch M1 and the second switch M2 are turned on, driving current flows through the organic light emitting diodes 120 and then flows to the ground VSS via the second sensing stripe 150, such that the organic light emitting diode 120 can emit light for displaying images. When the first switch M1 and the second switch M2 are turned off, the second sensing stripes 150 is no longer coupled to the ground VSS, and thereby the touch control mechanism 200 can start to operate for generating touch signals.

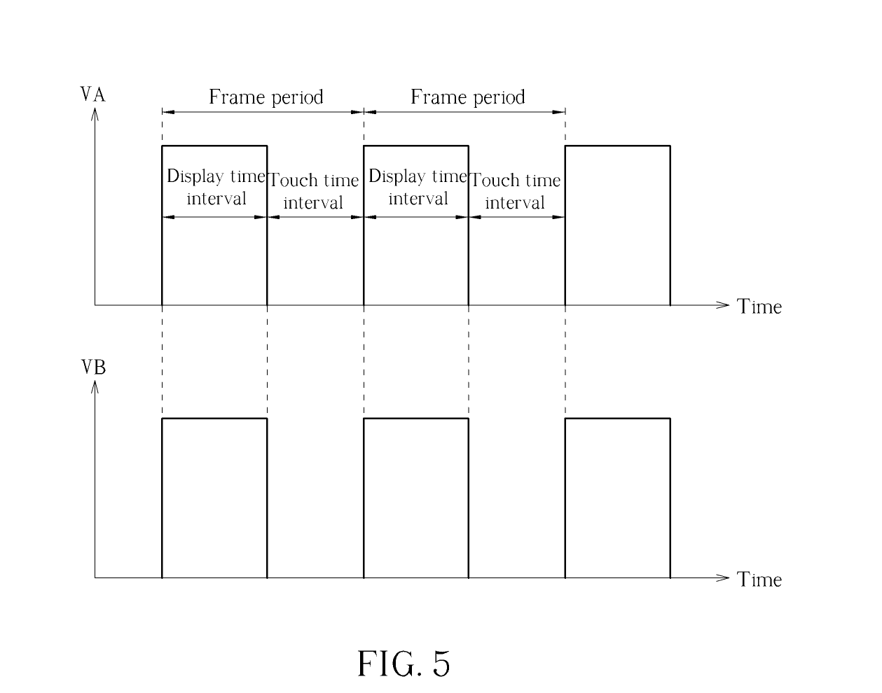

Please refer to FIG. 5, and refer to FIG. 4 as well. FIG. 5 is a diagram showing voltage signals of the control ends of the first switch and the second switch of FIG. 4. As shown in FIG. 5, when in a display time interval of a frame period, the display control circuit 310 increase voltages VA, VB of the control ends of the first switch M1 and the second switch M2 for turning on the first switch M1 and the second switch M2, so as to drive the organic light emitting diodes 120 to emit light for displaying an image of a frame. When in a touch time interval of the frame period, the display control circuit 310 decreases voltages VA, VB of the control ends of the first switch M1 and the second switch M2 for turning off the first switch M1 and the second switch M2, so as to allow the touch control mechanism 200 to operate for generating touch signals.

According to the above arrangement, the present invention arranges the first sensing stripes 130 on the protection substrate 140, and couples the second sensing stripes 150 to the cathodes 124 of the organic light emitting diodes 120, such that the display mechanism 300 and the touch control mechanism 200 can be integrated together into the organic light emitting diode display structure 100 of the present invention.

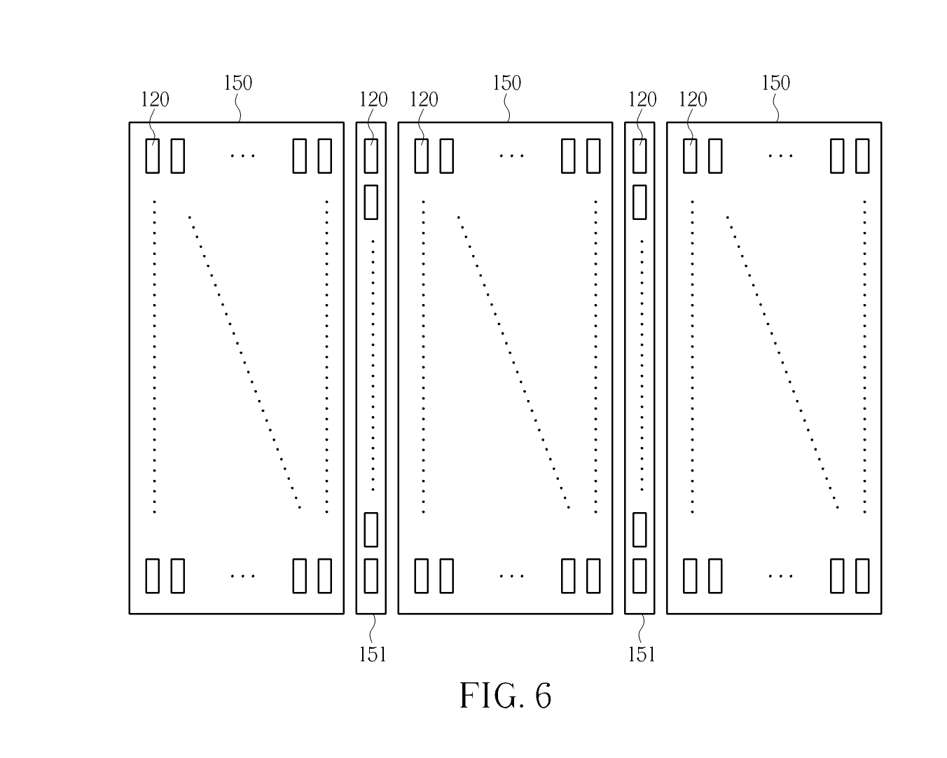

Please refer to FIG. 6. FIG. 6 is a diagram showing another embodiment of the second sensing stripes 150 of FIG. 1 being coupled to the cathodes 124 of the rows of the plurality of organic light emitting diodes 120. As shown in FIG. 6, in order to prevent signal interference caused by a short distance between each two of the second sensing stripes 150, each two of second sensing stripes 150 can be separated form each other by at least one row of the organic light emitting diodes 120 for increasing the distance between each two of the second sensing stripes 150. Cathodes of spacing rows 151 of the organic light emitting diodes 120 can be coupled to a layer of sensing electrode material for being jointly coupled to the ground VSS. However, the sensing electrode layer on the cathodes of the spacing rows 151 of the organic light emitting diodes 120 is not utilized for touch control.

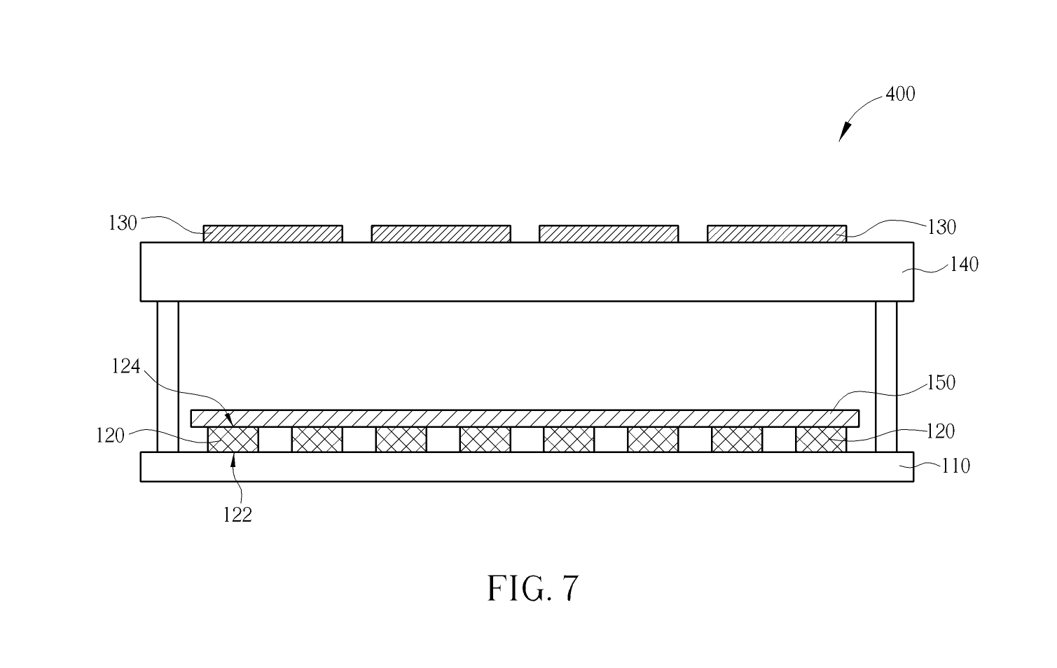

Please refer to FIG. 7. FIG. 7 is a diagram showing another embodiment of an organic light emitting diode display structure 400 with touch control function of the present invention. In FIG. 1, the first sensing stripes 130 are arranged on a lower surface of the protection substrate 140 along the first direction. However, as shown in FIG. 7, the first sensing stripes 130 can be also arranged on an upper surface of the protection substrate 140 along the first direction.

In contrast to the prior art, the present invention arranges the first sensing stripes on a protection substrate and couples the second sensing stripes to the cathodes of the organic light emitting diodes for integrating a display mechanism and a touch control mechanism into the organic light emitting diode display structure of the present invention. Therefore, thickness of a touch screen utilizing the organic light emitting diode display structure of the present invention can be further reduced, and production yields of the touch screen utilizing the organic light emitting diode display structure of the present invention can be further improved by skipping a step of attaching a touch panel onto a display panel.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display structure with touch control function, comprising:
a plurality of light emitting devices arranged in a matrix form;
a plurality of first switches, each of the first switch being coupled between a first end of one of the plurality of light emitting devices and a voltage source;
a plurality of first sensing stripes arranged along a first direction;
a plurality of second sensing stripes arranged along a second direction, each of the second sensing stripes being coupled to a plurality of second ends of at least one of rows of the plurality of light emitting devices and
a touch control circuit coupled to the plurality of first sensing stripes and the plurality of second sensing stripes for generating touch signals according to capacitance values between the plurality of first sensing stripes and the plurality of second sensing stripes.

2. The display structure of claim 1 further comprising a plurality of second switches, each of the second switches being coupled between one of the plurality of second sensing stripes and ground.

3. The display structure of claim 1, wherein the light emitting devices are organic light emitting diodes, and the first end is anode of one of the plurality of organic light emitting diodes, and the plurality of second ends are cathodes of the plurality of organic light emitting diodes.

4. The display structure of claim 2 further comprising a display control circuit for controlling on and off states of the plurality of first switches and the plurality of second switches.

5. The display structure of claim 4, wherein the display control circuit turns on the plurality of first switches and the plurality of second switches in a display time interval of a frame period, and turns off the plurality of first switches and the plurality of second switches in a touch time interval of the frame period.

6. The display structure of claim 1 further comprising a protection substrate arranged above the plurality of second sensing stripes, wherein the plurality of first sensing stripes are arranged on the protection substrate along the first direction.

7. The display structure of claim 6, wherein the plurality of first sensing stripes are arranged on an upper surface of the protection substrate along the first direction.

8. The display structure of claim 6, wherein the plurality of first sensing stripes are arranged on a lower surface of the protection substrate along the first direction.

9. The display structure of claim 1 further comprising a plurality of spacing patterns, wherein each one of the plurality of spacing patterns is disposed between each two of the second sensing stripes.

10. The display structure of claim 9, wherein the plurality of spacing patterns are coupled to the ground.

11. A display structure with touch control function, comprising:
a circuit substrate;
a plurality of light emitting devices formed on the circuit substrate in a matrix form, a plurality of first ends of the plurality of light emitting devices being coupled to the circuit substrate;
a plurality of first sensing stripes arranged along a first direction;
a plurality of second sensing stripes arranged along a second direction, each of the second sensing stripes being coupled to a plurality of second ends of at least one of rows of the plurality of light emitting devices, and each two of the second sensing stripes being separated from each other by at least one row of the plurality of light emitting devices; and
a touch control circuit coupled to the plurality of first sensing stripes and the plurality of second sensing stripes for generating touch signals according to capacitance values between the plurality of first sensing stripes and the plurality of second sensing stripes.

12. The display structure of claim 11, wherein the light emitting devices are organic light emitting diodes, and the first ends are anodes of the plurality of organic light emitting diodes, and the plurality of second ends are cathodes of the plurality of organic light emitting diodes.

13. The display structure of claim 11 further comprising a protection substrate arranged above the plurality of second sensing stripes, wherein the plurality of first sensing stripes are arranged on the protection substrate along the first direction.

14. The display structure of claim 13, wherein the plurality of first sensing stripes are arranged on an upper surface of the protection substrate along the first direction.

15. The display structure of claim 13, wherein the plurality of first sensing stripes are arranged on a lower surface of the protection substrate along the first direction.
